(19) United States
(12) Patent Application Publication
(10) Pub. No.: US 2025/0346249 A1
(43) Pub. Date: Nov. 13, 2025

(54) LOW-RANK ADAPTERS FOR WEATHER CONDITIONS IN 3D OBJECT TRACKING

(71) Applicant: QUALCOMM Incorporated, San Diego, CA (US)

(72) Inventors: Shubhankar Mangesh Borse, San Diego, CA (US); Ming-Yuan Yu, Austin, TX (US); Varun Ravi Kumar, San Diego, CA (US); Senthil Kumar Yogamani, Headford (IE)

(21) Appl. No.: 18/659,899

(22) Filed: May 9, 2024

(51) Int. Cl. B60W 60/00; G01W 1/06; G06T 7/60; G06T 7/73; G06V 10/764; G06V 20/56

(52) U.S. Cl. CPC B60W 60/001; G01W 1/06; G06T 7/60; G06T 7/73; G06V 10/764; G06V 20/56; B60W 2555/20; G06T 2200/04; G06T 2207/10028; G06T 2207/30192; G06T 2207/30252

(57) ABSTRACT

A method for processing image data includes receiving sensor data generated by one or more sensors of an autonomous vehicle and determining a weather condition based on the received sensor data. The method also includes identifying one or more adapter matrices of a plurality of adapter matrices integrated within one or more layers of a machine learning model based on the determined weather condition; and processing the received sensor data, using the one or more identified adapter matrices, to identify and/or track one or more objects in the received sensor data.

### TECHNICAL FIELD

This disclosure relates to image processing.

### BACKGROUND

A majority of current object tracking systems use cameras or LiDAR (light detection and ranging) sensors. Cameras capture light, and LiDAR uses lasers to build a three dimensional (3D) picture. Rain, snow, fog, and even bright sunlight may significantly affect such collected sensor data. Rain and fog make it difficult for cameras to clearly gather light reflected off of objects. Similarly, the lasers in LiDAR may struggle to penetrate rain or fog, complicating collection of accurate 3D measurements. Cameras may also receive reflections from bright sunlight, which may cause erroneous detections by artificial intelligence/machine learning (AI/ML) models.

### SUMMARY

In general, this disclosure describes techniques for efficient adaptive perception models that employ small, low-rank matrices called Low Rank Adapters (LoRAs). LoRAs may essentially adapt large object detection models and/or tracking models to new domains while staying efficient. LoRAs may function as dials that may be adjusted for different tasks. In an aspect, the rank (R) of LoRAs may be significantly smaller than the original feature dimension of the model. In other words, LoRAs may require far fewer parameters to train, making LoRAs memory-efficient. Because LoRA adapters are low-rank, such adapters may reduce variance. In simpler terms, LoRAs may be less prone to random fluctuations during training. Such stability may help ensure the LoRA focuses on capturing the essence of the new domain without introducing unnecessary noise or errors. Another important feature of LoRA is the ability to switch adapters on or off. Such switching may be performed by associating the corresponding adapter with an input weight. In an aspect, the system that employs LoRAs may determine to fully activate (weight=1) or completely deactivate (weight=0) the adapter depending on the situation.

In an aspect, contrary to conventional AI/ML models that are trained in essentially ideal weather conditions, AI/ML models per the techniques of this disclosure may include multiple LoRA adapters for different weather conditions, for example, a first LoRA adapter for rain, a second LoRA adapter for snow, and a third LoRA adapter for sunshine. The disclosed system may then activate the most relevant adapter based on the current weather.

As yet another non-limiting advantage, each LoRA adapter may be tailored to a specific domain, like a particular weather condition. By training an adapter on data specific to that weather, the disclosed system may learn the nuances of how objects behave in that environment.

In one example, a method for processing image data includes receiving sensor data generated by one or more sensors of an autonomous vehicle and determining a weather condition based on the received sensor data. The method also includes identifying one or more adapter matrices of a plurality of adapter matrices integrated within one or more layers of a machine learning model based on the determined weather condition; and processing the received sensor data, using the one or more identified adapter matrices, to identify and/or track one or more objects in the received sensor data.

In another example, an apparatus for processing image data includes a memory for storing sensor data; and processing circuitry in communication with the memory. The processing circuitry is configured to receive the sensor data generated by one or more sensors of an autonomous vehicle and to determine a weather condition based on the received sensor data. The processing circuitry is also configured to identify one or more adapter matrices of a plurality of adapter matrices integrated within one or more layers of a machine learning model based on the determined weather condition and to process the received sensor data, using the one or more identified adapter matrices, to identify and/or track one or more objects in the received sensor data.

In yet another example, non-transitory computer-readable storage media having instructions encoded thereon, the instructions configured to cause processing circuitry to: receive the sensor data generated by one or more sensors of an autonomous vehicle and to determine a weather condition based on the received sensor data. Additionally, the instructions are configured to cause the processing circuitry to identify one or more adapter matrices of a plurality of adapter matrices integrated within one or more layers of a machine learning model based on the determined weather condition and to process the received sensor data, using the one or more identified adapter matrices, to identify and/or track one or more objects in the received sensor data.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a diagram of an example autonomous vehicle, in accordance with the techniques of this disclosure.

FIG. 2 is a block diagram illustrating an example system that may perform the techniques of this disclosure.

FIG. 3 is a diagram illustrating a plurality of layers in an example large neural network in accordance with the techniques of this disclosure.

FIG. 4 is a diagram illustrating a plurality of LoRA adapters utilized in an example large neural network in accordance with the techniques of this disclosure.

FIG. 5 is a diagram illustrating training of the plurality of LoRA adapters of FIG. 4 in accordance with the techniques of this disclosure.

FIG. 6 is a block diagram illustrating an example system that may include a weather classifier in accordance with the techniques of this disclosure.

FIG. 7 is a flowchart illustrating an example method for providing sensor metadata using sensor imaging tensor in accordance with the techniques of this disclosure.

### DETAILED DESCRIPTION

Currently, neural networks used in autonomous driving system and/or an advanced driving assistance systems (ADAS) system are often trained on datasets collected in essentially ideal weather conditions. Such autonomous vehicles need to navigate a busy street. Furthermore, to drive safely, such autonomous vehicles typically need to not only see the objects around them (cars, pedestrians, bicycles) but also track movements of the objects and predict future positions of the objects. To have such functionality, autonomous vehicles may employ 3D object detection models and/or 3D tracking models. The 3D object detection model may be trained to identify objects and their location in a 3D space. Unlike traditional object detection approaches that work with two dimensional (2D) images, the 3D object detection model may deal with the real world's three dimensions (height, width, and depth). Common sensors used for 3D detection may include, but are not limited to, LiDAR (which use lasers to create a 3D point cloud) and stereo cameras (that capture two images from slightly different angles to create depth information). The detection process may involve algorithms that may analyze the sensor data and may identify objects. The output of the 3D object detection model is typically a 3D bounding box around the object, specifying location and size of the object in 3D space.

In an aspect, the 3D tracking model may build upon object detection. The 3D tracking model may be trained to follow the identified objects over time as they move in the 3D world. 3D tracking is important for tasks like autonomous driving systems, robots navigating an environment, and the like. There are two main approaches to 3D tracking: tracking-by-detection and Kalman filters. The system employing tracking-by-detection approach may first detect objects in each frame (image or point cloud) and then may try to associate detections across frames to determine if the frames belong to the same moving object. Kalman filters are mathematical tools that may use motion models to predict the future position of an object based on past movements and the current detection of the object. Kalman filters may help in handling occlusions (when objects are hidden from view momentarily). Both 3D detection and tracking are challenging tasks. Factors such as, but not limited to, bad weather, sensor noise, and complex environments may complicate accurate identification and tracking of objects.

Despite the challenges, 3D object detection and/or 3D tracking technologies have a wide range of applications. Precise 3D object detection and tracking are essential for safe autonomous navigation of the autonomous driving system. The use of 3D object detection and/or 3D tracking technologies may allow Augmented Reality (AR) systems to accurately place virtual objects in the real world and track their interaction with physical objects. Robots may use 3D object detection and tracking to perceive their surroundings, navigate obstacles, and manipulate objects.

The term “autonomous driving system,” as used herein, refers to vehicles that may navigate and operate without human input. Autonomous driving systems may involve a complex interplay of technologies. Sensors are the “eyes and ears” of the autonomous driving system, gathering information about the environment.

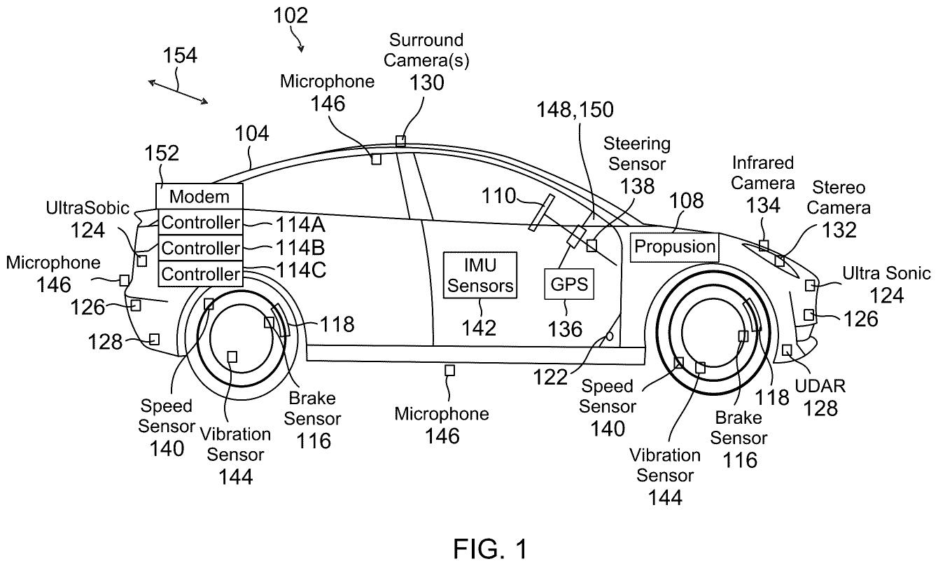

FIG. 1 shows an example vehicle 102. Vehicle 102 in the example shown may comprise a passenger vehicle such as a car or truck that can accommodate a human driver and/or human passengers. In an aspect, vehicle 102 may comprise an autonomous vehicle, semi-autonomous vehicle and/or an ADAS system. Vehicle 102 may include a vehicle body 104 suspended on a chassis, in this example comprised of four wheels and associated axles. A propulsion system 108 such as an internal combustion engine, hybrid electric power plant, or even all-electric engine may be connected to drive some or all of the wheels via a drive train, which may include a transmission (not shown). A steering wheel 110 may be used to steer some or all of the wheels to direct vehicle 102 along a desired path when the propulsion system 108 is operating and engaged to propel the vehicle 102. Steering wheel 110 or the like may be optional for Level 5 implementations. One or more controllers 114A-114C (a controller 114) may provide autonomous capabilities in response to signals continuously provided in real-time from an array of sensors, as described more fully below.

Each controller 114 may be essentially one or more onboard computers that may be configured to perform deep learning and/or artificial intelligence functionality and output autonomous operation commands to self-drive vehicle 102 and/or assist the human vehicle driver in driving. Each vehicle may have any number of distinct controllers for functional safety and additional features. For example, controller 114A may serve as the primary computer for autonomous driving functions, controller 114B may serve as a secondary computer for functional safety functions, controller 114C may provide artificial intelligence functionality for in-camera sensors, and controller 114D (not shown) may provide infotainment functionality and provide additional redundancy for emergency situations.

Controller 114 may send command signals to operate vehicle brakes 116 via one or more braking actuators 118, operate steering mechanism via a steering actuator, and operate propulsion system 108 which also receives an accelerator/throttle actuation signal 122. Actuation may be performed by methods known to persons of ordinary skill in the art, with signals typically sent via the Controller Area Network data interface (“CAN bus”)—a network inside modern cars used to control brakes, acceleration, steering, windshield wipers, and the like. The CAN bus may be configured to have dozens of nodes, each with its own unique identifier (CAN ID). The bus may be read to find steering wheel angle, ground speed, engine RPM, button positions, and other vehicle status indicators. The functional safety level for a CAN bus interface is typically Automotive Safety Integrity Level (ASIL) B. Other protocols may be used for communicating within a vehicle, including FlexRay and Ethernet.

In an aspect, an actuation controller may be obtained with dedicated hardware and software, allowing control of throttle, brake, steering, and shifting. The hardware may provide a bridge between the vehicle's CAN bus and the controller 114, forwarding vehicle data to controller 114 including the turn signal, wheel speed, acceleration, pitch, roll, yaw, Global Positioning System (“GPS”) data, tire pressure, fuel level, sonar, brake torque, and others. Similar actuation controllers may be configured for any other make and type of vehicle, including special-purpose patrol and security cars, robo-taxis, long-haul trucks including tractor-trailer configurations, tiller trucks, agricultural vehicles, industrial vehicles, and buses.

Controller 114 may provide autonomous driving outputs in response to an array of sensor inputs including, for example: one or more ultrasonic sensors 124, one or more RADAR sensors 126, one or more LiDAR sensors 128, one or more surround cameras 130 (typically such cameras are located at various places on vehicle body 104 to image areas all around the vehicle body), one or more stereo cameras 132 (in an aspect, at least one such stereo camera may face forward to provide object recognition in the vehicle path), one or more infrared cameras 134, GPS unit 136 that provides location coordinates, a steering sensor 138 that detects the steering angle, speed sensors 140 (one for each of the wheels), an inertial sensor or inertial measurement unit (“IMU”) 142 that monitors movement of vehicle body 104 (this sensor can be for example an accelerometer(s) and/or a gyro-sensor(s) and/or a magnetic compass(es)), tire vibration sensors 144, and microphones 146 placed around and inside the vehicle. Other sensors may be used, as is known to persons of ordinary skill in the art.

Controller 114 may also receive inputs from an instrument cluster 148 and may provide human-perceptible outputs to a human operator via human-machine interface (“HMI”) display(s) 150, an audible annunciator, a loudspeaker and/or other means. In addition to traditional information such as velocity, time, and other well-known information, HMI display 150 may provide the vehicle occupants with information regarding maps and vehicle's location, the location of other vehicles (including an occupancy grid) and even the Controller's identification of objects and status. For example, HMI display 150 may alert the passenger when the controller 114 has identified the presence of a stop sign, caution sign, or changing traffic light and is taking appropriate action, giving the vehicle occupants peace of mind that the controller 114 is functioning as intended.

In an aspect, instrument cluster 148 may include a separate controller/processor configured to perform deep learning and artificial intelligence functionality.

Vehicle 102 may collect data that is preferably used to help train and refine the neural networks used for autonomous driving. The vehicle 102 may include modem 152, preferably a system-on-a-chip that provides modulation and demodulation functionality and allows the controller 114 to communicate over the wireless network 154. Modem 152 may include an RF front-end for up-conversion from baseband to RF, and down-conversion from RF to baseband, as is known in the art. Frequency conversion may be achieved either through known direct-conversion processes (direct from baseband to RF and vice-versa) or through super-heterodyne processes, as is known in the art. Alternatively, such RF front-end functionality may be provided by a separate chip. Modem 152 preferably includes wireless functionality substantially compliant with one or more wireless protocols such as, without limitation: LTE, WCDMA, UMTS, GSM, CDMA2000, or other known and widely used wireless protocols.

It should be noted that, compared to sonar and RADAR sensors 126, cameras 130-134 may generate a richer set of features at a fraction of the cost. Thus, vehicle 102 may include a plurality of cameras 130-134, capturing images around the entire periphery of the vehicle 102. Camera type and lens selection depends on the nature and type of function. The vehicle 102 may have a mix of camera types and lenses to provide complete coverage around the vehicle 102; in general, narrow lenses do not have a wide field of view but can see farther. All camera locations on the vehicle 102 may support interfaces such as Gigabit Multimedia Serial link (GMSL) and Gigabit Ethernet.

In an aspect, a controller 114 may receive sensor data from sensors (LiDAR, radar) and potentially cameras on the autonomous vehicle. Controller 114 may analyze the sensor data to determine the current weather condition (e.g., sunny, rainy, snowy). Based on the determined weather condition, controller 114 may identify one or more adapter matrices (LoRAS) that may be integrated within a machine learning model. Next, controller 114 may process the received sensor data, using the identified adapter matrices. These adapter matrices may adjust the processing for the specific weather conditions. For example, a rain-adapted adapter matrix may enhance contrast or remove noise specific to raindrops on the camera lens.

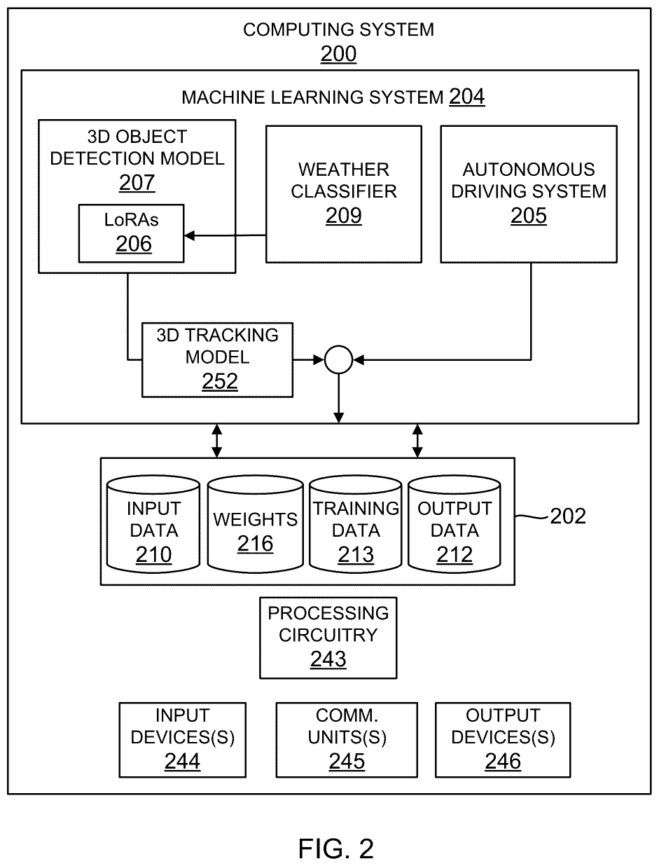

FIG. 2 is a block diagram illustrating an example computing system 200. As shown, computing system 200 comprises processing circuitry 243 and memory 202 for executing a machine learning system 204, which may represent an example instance of any controller 114 described in this disclosure, such as controller 114 of FIG. 1. In an aspect, machine learning system 204 may include, but is not limited to 3D object detection model 207 that may include a plurality of LoRAs 206, 3D tracking model 252, multi-label classifier 209 and autonomous driving system 205. 3D object detection model 207, 3D tracking model 252, weather classifier 209 and autonomous driving system 205 may comprise various types of neural networks, such as, but not limited to, recursive neural networks (RNNs), convolutional neural networks (CNNs), and deep neural networks (DNNs).

Computing system 200 may also be implemented as any suitable external computing system accessible by controller 114, such as one or more server computers, workstations, laptops, mainframes, appliances, cloud computing systems, High-Performance Computing (HPC) systems (i.e., supercomputing) and/or other computing systems that may be capable of performing operations and/or functions described in accordance with one or more aspects of the present disclosure. In some examples, computing system 200 may represent a cloud computing system, server farm, and/or server cluster (or portion thereof) that provides services to client devices and other devices or systems. In other examples, computing system 200 may represent or be implemented through one or more virtualized compute instances (e.g., virtual machines, containers, etc.) of a data center, cloud computing system, server farm, and/or server cluster.

The techniques described in this disclosure may be implemented, at least in part, in hardware, software, firmware or any combination thereof. For example, various aspects of the described techniques may be implemented within processing circuitry 243 of computing system 200, which may include one or more of a microprocessor, a controller, a digital signal processor (DSP), an application specific integrated circuit (ASIC), a field-programmable gate array (FPGA), or equivalent discrete or integrated logic circuitry, or other types of processing circuitry. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

In another example, computing system 200 comprises any suitable computing system having one or more computing devices, such as desktop computers, laptop computers, gaming consoles, smart televisions, handheld devices, tablets, mobile telephones, smartphones, etc. In some examples, at least a portion of computing system 200 is distributed across a cloud computing system, a data center, or across a network, such as the Internet, another public or private communications network, for instance, broadband, cellular, Wi-Fi, ZigBee, Bluetooth® (or other personal area network—PAN), Near-Field Communication (NFC), ultrawideband, satellite, enterprise, service provider and/or other types of communication networks, for transmitting data between computing systems, servers, and computing devices.

Memory 202 may comprise one or more storage devices. One or more components of computing system 200 (e.g., processing circuitry 243, memory 202, etc.) may be interconnected to enable inter-component communications (physically, communicatively, and/or operatively). In some examples, such connectivity may be provided by a system bus, a network connection, an inter-process communication data structure, local area network, wide area network, or any other method for communicating data. Processing circuitry 243 of computing system 200 may implement functionality and/or execute instructions associated with computing system 200. Examples of processing circuitry 243 include microprocessors, application processors, display controllers, auxiliary processors, one or more sensor hubs, and any other hardware configured to function as a processor, a processing unit, or a processing device. Computing system 200 may use processing circuitry 243 to perform operations in accordance with one or more aspects of the present disclosure using software, hardware, firmware, or a mixture of hardware, software, and firmware residing in and/or executing at computing system 200. The one or more storage devices of memory 202 may be distributed among multiple devices.

Memory 202 may store information for processing during operation of computing system 200. In some examples, memory 202 comprises temporary memories, meaning that a primary purpose of the one or more storage devices of memory 202 is not long-term storage. Memory 202 may be configured for short-term storage of information as volatile memory and therefore not retain stored contents if deactivated. Examples of volatile memories include random access memories (RAM), dynamic random-access memories (DRAM), static random-access memories (SRAM), and other forms of volatile memories known in the art. Memory 202, in some examples, may also include one or more computer-readable storage media. Memory 202 may be configured to store larger amounts of information than volatile memory. Memory 202 may further be configured for long-term storage of information as non-volatile memory space and retain information after activate/off cycles. Examples of non-volatile memories include magnetic hard disks, optical discs, Flash memories, or forms of electrically programmable memories (EPROM) or electrically erasable and programmable (EEPROM) memories. Memory 202 may store program instructions and/or data associated with one or more of the modules described in accordance with one or more aspects of this disclosure.

Processing circuitry 243 and memory 202 may provide an operating environment or platform for one or more modules or units (e.g., 3D object detection model 207, 3D tracking model 252, weather classifier 209 and one or more LoRAs 206), which may be implemented as software, but may in some examples include any combination of hardware, firmware, and software. Processing circuitry 243 may execute instructions and the one or more storage devices, e.g., memory 202, may store instructions and/or data of one or more modules. The combination of processing circuitry 243 and memory 202 may retrieve, store, and/or execute the instructions and/or data of one or more applications, modules, or software. The processing circuitry 243 and/or memory 202 may also be operably coupled to one or more other software and/or hardware components, including, but not limited to, one or more of the components illustrated in FIG. 2.

Processing circuitry 243 may execute machine learning system 204 using virtualization modules, such as a virtual machine or container executing on underlying hardware. One or more of such modules may execute as one or more services of an operating system or computing platform. Aspects of machine learning system 204 may execute as one or more executable programs at an application layer of a computing platform.

One or more input devices 244 of computing system 200 may generate, receive, or process input. Such input may include input from a video camera, sensor, keyboard, pointing device, voice responsive system, biometric detection/response system, button, mobile device, control pad, microphone, presence-sensitive screen, network, or any other type of device for detecting input from a human or machine.

One or more output devices 246 may generate, transmit, or process output. Examples of output are tactile, audio, visual, and/or video output. Output devices 246 may include a display, sound card, video graphics adapter card, speaker, presence-sensitive screen, one or more USB interfaces, video and/or audio output interfaces, or any other type of device capable of generating tactile, audio, video, or other output. Output devices 246 may include a display device, which may function as an output device using technologies including liquid crystal displays (LCD), quantum dot display, dot matrix displays, light emitting diode (LED) displays, organic light-emitting diode (OLED) displays, cathode ray tube (CRT) displays, e-ink, or monochrome, color, or any other type of display capable of generating tactile, audio, and/or visual output. In some examples, computing system 200 may include a presence-sensitive display that may serve as a user interface device that operates both as one or more input devices 244 and one or more output devices 246.

One or more communication units 245 of computing system 200 may communicate with devices external to computing system 200 (or among separate computing devices of computing system 200) by transmitting and/or receiving data, and may operate, in some respects, as both an input device and an output device. In some examples, communication units 245 may communicate with other devices over a network. In other examples, communication units 245 may send and/or receive radio signals on a radio network such as a cellular radio network. Examples of communication units 245 include a network interface card (e.g., such as an Ethernet card), an optical transceiver, a radio frequency transceiver, a GPS receiver, or any other type of device that can send and/or receive information. Other examples of communication units 245 may include Bluetooth®, GPS, 3G, 4G, and Wi-Fi® radios found in mobile devices as well as Universal Serial Bus (USB) controllers and the like.

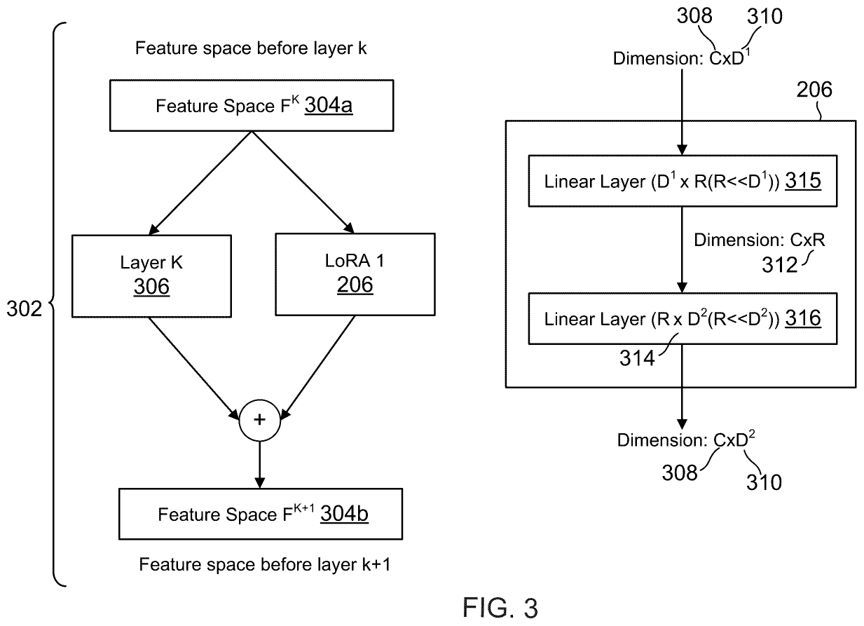

In the example of FIG. 2, 3D object detection model 207 and weather classifier 209 may receive input data 210. 3D tracking model 252 may generate output data 212. Output data generated by weather classifier 209 may be used as input data (e.g., weights 216) for one or more LoRAs 206 (as shown in FIG. 3) of the machine learning system 204. Input data 210 and output data 212 may contain various types of information. For example, input data 210 may include, but is not limited to, image data, video data, LiDAR data, and so on. Output data 212 may include a plurality of tracked boxes, identified objects and their location in a 3D space, and so on.

Machine learning system 204 may receive input from sensors such as, but not limited to, cameras 130-134, LiDAR sensors 128, RADAR sensors 126, and/or ultrasonic sensors 124. In an aspect, cameras 130-134 and LiDAR sensors 128 may play an important role in autonomous driving by providing visual data. Cameras 130-134 and LiDAR sensors 128 may capture information such as, but not limited to, lane markings, traffic signals, pedestrians, and other vehicles. Machine learning system 204 may employ 3D object detection model 207 and 3D tracking model 252 to process input data 210 to identify objects, understand movements of the identified objects, and classify the identified objects (e.g., car, pedestrian, and the like). AR simulations may create realistic driving scenarios for training purposes. AR displays in the vehicle 102 may show passengers real-time information about surroundings or the route. Machine learning system 204 may utilize VR simulations to test vehicle 102 in various weather conditions and traffic scenarios before real-world deployment. Sensors like cameras 130-134 and LiDAR sensors 128 may constantly gather data about the environment. Using the received sensor data, machine learning system 204 may generate a real-time map of surroundings of vehicle 102 and may identify potential obstacles or traffic signals. Machine learning system 204 may then plan the safest route and driving strategy. Based on the plan, autonomous driving system 205 (the control system of the vehicle 102) may take over steering, acceleration, and braking to execute the planned maneuvers. It should be noted that sensors may be affected by weather conditions, making it difficult for machine learning system 204 to perceive the environment accurately.

In an aspect, a point cloud may be a large cloud of dots floating in space. Each dot may represent a single data point with corresponding X, Y, and Z coordinates. Sensors like LiDAR sensors 128 may capture point clouds by sending out laser pulses and measuring the reflected light's time-of-flight. Point clouds may provide a detailed and accurate representation of the 3D environment, including, but not limited to, objects, surfaces, and even small details.

The world is dynamic, and objects may move. In autonomous driving, for instance, the scene may keep changing as the vehicle 102 moves. A point cloud sequence may capture such dynamism. A point cloud sequence may be a series of point clouds captured at consecutive moments, like frames in a video, but representing the 3D world.

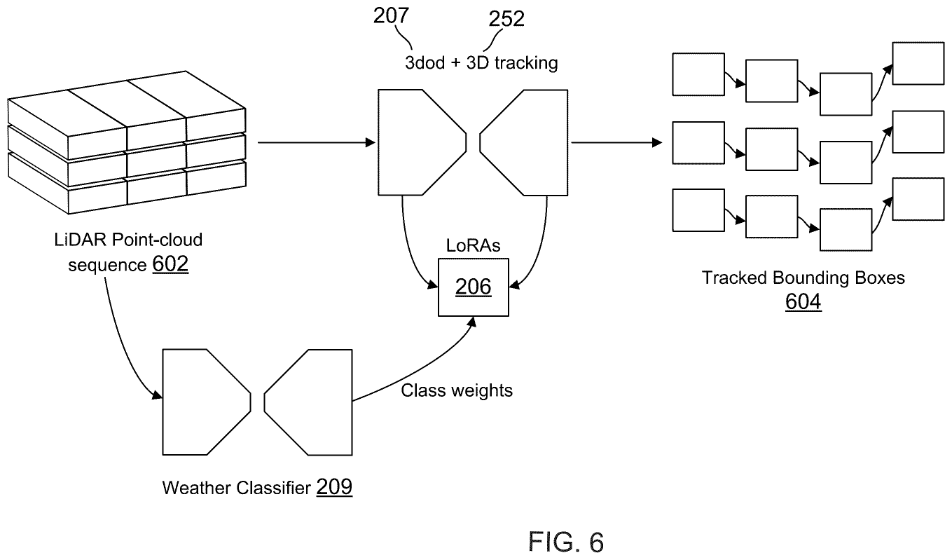

By analyzing point cloud sequences, machine learning system 204 may track object movements and may predict future positions of one or more objects. The 3D object detection model 207 may be trained to identify and locate objects within a point cloud (or sequence). Unlike 2D object detection in images (where boxes may be drawn around objects in a picture), 3D object detection model 207 deals with the 3D world. The 3D object detection model 207 may draw 3D bounding boxes (shown in FIG. 6) around the detected objects in the point cloud. The drawn boxes may specify location (X, Y, Z) of the object and size (width, height, depth) of the object in 3D space.

Point cloud sequences may provide a rich stream of data for 3D object detection. By analyzing consecutive point clouds, machine learning system 204 may not only identify objects in each frame but also track movements of the identified objects across frames. 3D object detection model 207 may output 3D bounding boxes drawn on the point cloud sequences that may visually represent the detected objects and movements of the detected objects in the 3D world. 3D bounding boxes may be important for identifying and tracking cars, pedestrians, and other obstacles on the road. In other implementations, 3D bounding boxes may help robots perceive surroundings and avoid collisions with objects. XR/AR/VR systems may precisely place virtual objects in the real world based on the 3D structure captured by the point cloud sequence.

Multi-Object tracking (MOT) is the task of following and identifying multiple objects over time in a video or sequence of images. However, traditional MOT approaches often struggle with challenges like occlusions (objects being hidden) or sudden changes in appearance. Bi-directional Multi-Object Tracking may tackle the aforementioned issues by introducing a two-way flow of information between the 3D tracking model 252 and 3D object detection model 207. The 3D tracking model 252 may receive tracking input. The term “tracking input,” as used herein, refers to the data that may be used by 3D tracking model 252 to track objects. In the illustrated example, tracking input may be the detections from 3D object detection model 207 in each frame. The 3D object detection model 207 may identify a car, a person, or any object of interest in the image/point cloud.

3D tracking model 252 may generate tracking output (output data 212). Tracking output may be the result of the tracking process. Output data 212 may include information, such as, but not limited to, ID of the object (to differentiate between multiple objects), trajectory of the object (path the object takes over time), and bounding box of the object in each frame. It should be noted that traditional MOT approaches typically have a one-way flow: detections are inputted into the tracking model, and tracks come out as output. In an aspect, machine learning system 204 may implement bidirectional MOT techniques. Similar to traditional MOT, 3D tracking model 252 may receive detections from each frame. However, 3D tracking model 252 may not just output final tracks. 3D tracking model 252 may also send information back to the 3D object detection model 207. Such information may include, but is not limited to, predicted locations of existing tracks or “lost” object locations where the 3D tracking model 252 determined an object might have reappeared after an occlusion.

In an aspect, the aforementioned two-way flow may allow the 3D tracking model 252 and 3D object detection model 207 to “communicate” and improve performance of each other. In an aspect, by predicting object locations, the 3D tracking model 252 may help the 3D object detection model 207 identify objects even when they are partially hidden. In an aspect, the backward pass may allow the 3D tracking model 252 to correct potential errors in previous frames, leading to more accurate and stable tracks.

In an aspect, in MOT, machine learning system 204 may be trained to not just detect objects in each frame of a point cloud sequence and/or a video but also follow objects over time, understanding movement and behavior of the detected objects.

In an aspect, as discussed above, the output of the 3D tracking model 252 (e.g., output data 212) may include, but is not limited to: object ID, bounding box and trajectory. In an aspect, object ID may be a unique identifier that differentiates between multiple objects being tracked. In an aspect, in each frame, a bounding box (e.g., a cuboid in 3D) may specify the location and size of the object in the image or point cloud. In an aspect, the trajectory may represent the path of the object throughout the video and/or point cloud sequence. The trajectory may be represented by a series of points or more complex mathematical models depending on the machine learning system 204.

The aforementioned bounding boxes and trajectory points are typically in image coordinates or point cloud coordinates. Such coordinates are relative positions within the image or point cloud itself. To understand the movement of the object in the real world, machine learning system 204 may need to convert the trajectory points to world coordinates.

The process of conversion of the trajectory points to world coordinates may require additional information about the camera or sensor setup. In simpler terms, the machine learning system 204 may need to know the relationship between the image/point cloud coordinates and the actual physical dimensions of the space being captured.

A full-length track represents the complete path of an object throughout the entire video/point cloud sequence. However, due to weather conditions, detection errors, or other challenges, the 3D tracking model 252 may lose track of an object in some frames. The 3D tracking model 252 may propose full-length tracks even when there are gaps in the data. In an aspect, 3D tracking model 252 may attempt to reconstruct the entire trajectory by utilizing one or more LoRAs 206 to bridge gaps in the data that were caused by weather conditions. As noted above, understanding the 3D positions and movements of vehicles, pedestrians, and other objects in the real world is essential for safe navigation of vehicles 102.

In alternative applications, robots may rely on tracking objects in their environment to avoid collisions and interact with the world effectively.

In an aspect, each object being tracked by 3D tracking model 252 may have its own “fingerprint”—a set of features that may help identify and distinguish the object from others. In an aspect, 3D tracking model 252 may perform track feature extraction.

Track feature extraction may involve analyzing the data associated with a track and extracting these features. The type of data and features being extracted may vary depending on the application. For videos, the extracted features may include, but are not limited to, appearance information like color histograms, textures, or even object shapes extracted from bounding boxes. Motion information like velocity and direction may also be features.

In an aspect, for point clouds (3D data), the extracted features may include, but are not limited to, geometric properties (size, shape) extracted from 3D points associated with the track, as well as intensity values from the LiDAR sensor 128. Not all data points within a track's bounding box may be equally informative. Using the extracted features, the machine learning system 204 may choose to focus on specific data points (e.g., points on the edges for better shape recognition) within the bounding box for further processing. The chosen points are called “crop points.” By focusing on informative data points, the machine learning system 204 may extract more relevant and robust features for the specific track.

When machine learning system 204 gets a set of informative crop points, the machine learning system 204 may extract more detailed object features. For purposes of explanation, in 2D (videos), machine learning system 204 may extract deeper features like local feature descriptors or deep learning features from convolutional neural networks trained on object recognition tasks.

In an aspect, in 3D point clouds, machine learning system 204 may analyze the spatial relationships between the crop points to extract detailed 3D object features that capture the shape and geometry of the object more precisely. The machine learning system 204 may use the extracted object features to refine the initial 3D bounding boxes (in case of 3D point clouds) or bounding boxes in each frame (in case of 2D videos). In an aspect, such refinement may involve adjusting the box size and orientation. For example, the adjusted bounding box may indicate a more precise size or tilt of the object compared to the initial bounding box. The machine learning system 204 may use the extracted features to estimate the pose of the object (e.g., a car turning a corner). In an aspect, by extracting informative features and using them to refine bounding boxes, the machine learning system 204 (e.g., 3D tracking model 252) may achieve better accuracy. In an aspect, machine learning system 204 may distinguish between similar-looking objects more effectively using the extracted features.

Rain, snow, and other weather conditions may significantly affect performance of the 3D tracking model 252 designed for LiDAR data. Rain and snow may weaken the LiDAR signal, making it harder to capture clear reflections from objects. The weakened LiDAR signal may result in sparse and noisy point clouds, with missing data points. For example, seeing through a downpour may be as difficult for LiDAR sensors as for people. Falling snowflakes may be misinterpreted as objects, leading to “ghost detections” (false positives) in the point cloud. Conversely, real objects may be partially or completely obscured by rain or snow, causing such objects to be missed (false negatives).

Due to the inconsistencies in the point cloud, the machine learning system 204 may struggle to create accurate 3D bounding boxes around vehicles. For example, if a car has snow piled on its roof-the bounding box may not capture true size and shape of the car.

In an aspect, inaccurate bounding boxes and missing data may lead to tracking errors. The machine learning system 204 may lose track of a vehicle entirely or may mistake the vehicle for another object due to the noisy data. Some existing approaches for improving vehicle tracking performance in bad weather may combine LiDAR data with other sensors like cameras 130-134 or RADAR sensors 126 that may provide complementary information. Cameras 130-134 may be able to identify the shape of a car even if the LiDAR point cloud is noisy. RADAR sensors 126 may offer better visibility through rain or fog.

Some recent approaches apply adaptation to varying weather conditions by training different models for each weather condition. Overall, training a separate model for each weather condition has its limitations. Training multiple models essentially replicates a lot of effort. Such trained models likely share some core functionalities for object recognition and tracking that do not need to be relearned for each weather condition. Such training approach may be a waste of computational resources and time.

When a new model is trained for a specific weather condition (e.g., rain), such model may forget what the model learned for other conditions (e.g., sunny, snow). Such forgetting is called catastrophic forgetting. Catastrophic forgetting may significantly reduce the overall performance of the system, especially in transitioning weather scenarios.

Training data 213 always has some inherent bias, reflecting the conditions in which the data was collected. If a separate model is trained for rain using data with mostly light rain, the trained model may struggle with heavy downpours. Such bias may limit the generalizability of the weather-specific models.

In an aspect, machine learning system 204 may have a separate weather condition classifier (weather classifier 209) as part of the system. In an aspect, the weather classifier 209 may be a simple convolutional neural network (CNN) trained on labeled images or LiDAR scans categorized by weather conditions (e.g., rainy, dark, snow, clear), as discussed below in conjunction with FIG. 6.

FIG. 3 is a diagram illustrating a plurality of layers in an example large neural network in accordance with the techniques of this disclosure. A large neural network may have a series of layers 302, each processing the data and extracting features. These features are essentially representations of the information learned by the network at that stage. Each layer may have its own feature space 304, which is a high-dimensional space where these features reside. In other words, the feature space 304 is a vast container holding all the information the network has learned up to that point. In an aspect, LoRA 206 works by introducing small, low-rank matrices called adapters between certain feature spaces 304 in the machine learning model. In an aspect, these adapters may operate on the feature space at a specific layer (e.g., layer K 306) and influence the features outputted by that layer.

Feature space F^{k} 304a represents the feature space before layer K 306. Feature space F^{k} 304a may contain the high-dimensional features extracted by the previous layers of the machine learning model (e.g., 3D object detection model 207). LoRA adapter 206 may be a low-rank matrix inserted within the layer K 306. LoRA adapter 206 may act like a “switch” that can be turned on or off with a weight. When activated, LoRA adapter 206 may modify the features processed by layer K 306 before these features are sent to the next feature space. Feature space F^{k+1} 304b represents the feature space after layer K 306. The features in F^{k+1} 304b may be influenced by both the original features in F^{k} 304 and the adjustments made by the LoRA adapter 206. In an aspect, LoRA adapters 206 may be much smaller than the original feature spaces 304 (F^{k} and F^{k+1}) because they are low-rank matrices, requiring far fewer parameters to train.

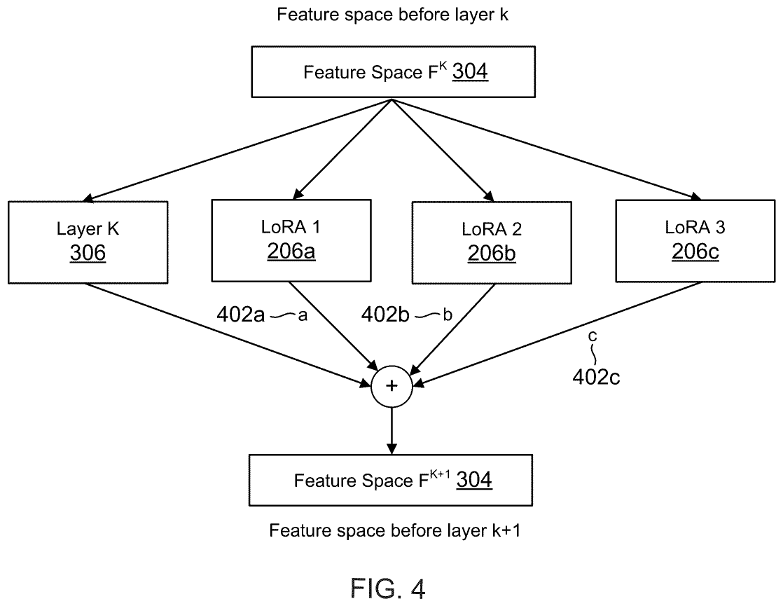

LoRAs 206 are a memory-efficient way to adapt the machine learning model. A separate LoRA adapter 206 may be trained for each weather condition (rain, snow, sunshine), as shown in FIG. 4. Each LoRA adapter 206 may learn the specific adjustments needed for that condition, modifying the features in feature space F^{k} 304a before they are processed by layer K 306. LoRAs 206 may allow the machine learning model to maintain its core functionality while adapting to the new domain.

Referring back to FIG. 3, ‘C’ 308 may represent the number of input channels to the layer. The data flowing through the network may be viewed as having multiple channels, each carrying specific information. ‘C’ 308 may indicate how many of these channels the layer is processing. D¹ and D² 310 may represent the dimensionality of the feature spaces before and after the linear layers, respectively. In an aspect, as data progresses through the network, the data may get transformed into higher-dimensional or lower-dimensional feature spaces.

R 312 may represent the rank of the LoRA adapter 206. As noted above, LoRA adapters 206 may be low-rank matrices. In other words, LoRA adapters 206 may have a smaller number of rows and columns compared to the feature spaces they operate on (R <<D¹ and R<<D²). Dimension C×D¹ may represent a linear layer in the machine learning model before the LoRA adapter 206 is applied. LoRA 206 may take C 308 input channels and transform them into a D¹-dimensional 310 feature space. In an aspect, dimension C×R (R<<D¹) may represent the LoRA adapter 206 itself. LoRA adapter 206 is a low-rank matrix with Crows (same as the number of input channels) and R columns. The key point here is that R (the rank) 312 is much smaller than D¹ 310 (the dimensionality of the feature space 304 before the LoRA adapter 206). Such low-rank property makes LoRA memory-efficient. Dimension R×D² 314 (R<<D²) may represent another linear layer 316 in the machine learning model after the LoRA adapter 206. The LoRA adapter 206 with its R columns may act as the input to this layer 316. The layer 316 may then transform this R-dimensional input into a D². dimensional feature space. Data may flow through the network, reaching the first linear layer 315 (C×D¹). The LoRA adapter 206 (C×R) may multiply the output of the first linear layer 315, essentially applying domain-specific adjustments based on the learned weights of the LoRA adapter 206 (trained for a specific weather condition, for example). In an aspect, the result of this multiplication (which has the same dimensionality, C×R, as the LoRA adapter 206) may be fed into the next linear layer 316 (R×D²). In an aspect, the final linear layer 316 may transform the adapter-influenced features into a new feature space 304b (D²).

Traditional adaptation techniques often involve retraining a significant portion of the machine learning model for a new domain. Traditional adaptation techniques may be computationally expensive and time-consuming.

The disclosed techniques may take a different approach. The disclosed techniques may introduce small, low-rank matrices called LoRA adapters 206 between specific layers in the original model. The key to efficiency of the LoRA 206 lies in the rank (R) 312 of the adapter matrix. This rank may be much smaller than the dimensionality (D) of the feature spaces the adapter interacts with (R<<D).

LoRA adapter 206 may not discard information from the source domain (the original training data 213). The machine learning model architecture and its core functionality may remain intact. Due to low-rank adapters, LoRA 206 may require significantly less memory and computational resources compared to retraining the entire machine learning model. Memory efficiency may be important for deploying large models on resource-constrained devices. LoRA adapters 206 may be trained much faster than retraining the entire machine learning model, making it easier to adapt the machine learning model to new domains quickly. LoRA adapters 206 may leverage the knowledge from the source domain while adapting to the new domain, leading to better overall performance.

High variance in a machine learning model refers to a tendency of a machine learning model to perform significantly differently on new data compared to its training data 213. High variance may be problematic for adaptation because the LoRA adapter 206 might overfit to the new domain and lose ability to generalize.

LoRA adapters 206 may address high variance issue by having low-rank matrices. The low-rank matrices may have a smaller number of rows and columns compared to the feature spaces they operate on. Such inherent structure may help to reduce variance in the LoRA adapters 206.

Features may reside in a high-dimensional space. A high-rank LoRA adapter 206 would need many parameters to capture all the variations within this space. A low-rank LoRA adapter 206, on the other hand, focuses on capturing the most important aspects of the variations using fewer parameters. Such focus may lead to a more stable and generalizable adapter.

As noted above, LoRA adapters 206 may act like switches that may be turned on or off during the adaptation process. Such control may be achieved by multiplying the LoRA adapter 206 with an input weight. The LoRA adapter 206 itself may be a matrix with learned weights. In an aspect, a separate input weight may be a scalar value, such as 1 or 0.

In an aspect, by multiplying the adapter matrix with the input weight, machine learning system 204 may essentially control the impact of the LoRA adapter 206 on the features. Conversely, a low input weight (0) may cancel the influence of the LoRA adapter 206, essentially “turning off the switch” and relying essentially on the features of the machine learning model. Low variance in LoRA adapters 206 may help prevent machine learning models from overfitting to the new domain (weather related data) and may allow the machine learning models to generalize better. Such flexibility may be beneficial in scenarios where a complete shift to the new domain might not be necessary (e.g., in transitioning weather scenarios).

FIG. 4 is a diagram illustrating a plurality of LoRA adapters utilized in an example large neural network in accordance with the techniques of this disclosure. As shown in FIG. 4, machine learning system 204 may train and employ a plurality of individual LoRA adapters 206a-206c for each weather condition. Each LoRA adapter 206a-206c may be a low-rank matrix inserted between specific layers in the machine learning model. Furthermore, each LoRA adapter 206a-206c may be associated with a separate input weight 402a-402c.

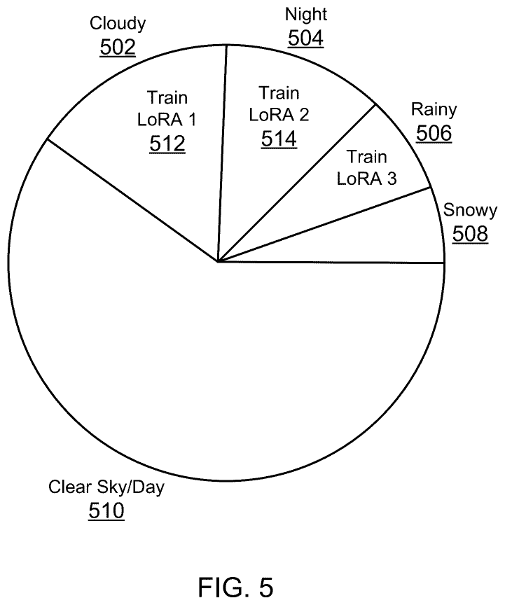

FIG. 5 is a diagram illustrating training of the plurality of LoRA adapters of FIG. 4 in accordance with the techniques of this disclosure. In an aspect, machine learning system 204 may start training by training a machine learning model (e.g., 3D object detection model 207) on a large training dataset 213 that may include driving scenes encompassing various weather conditions (e.g., cloudy, night, rainy, snowy, clear sky/day). Such training dataset 213 may include information like LiDAR point clouds, camera images, and potentially other sensor data relevant to self-driving tasks. The machine learning model (e.g., 3D object detection model 207) may learn core functionalities for object detection, scene understanding, and potentially other tasks important for autonomous driving.

During training, once machine learning system 204 has the machine learning model trained, machine learning system 204 may split the original training dataset 213 by weather condition. Such split may create separate datasets for cloudy 502, night 504, rainy 506, snowy 508, and clear sky/day 510 scenarios. Next, machine learning system 204 may train 512-514 individual LoRA adapters 206a-206c (shown in FIG. 4) for each weather condition (e.g., LoRA1 206a using cloudy dataset 502, LoRA 2 using night data set 504, and so on). Each LoRA adapter 206a-206c may be a low-rank matrix inserted between specific layers in the machine learning model. During training, each LoRA adapter 206a-206c may learn to modify the features extracted by the machine learning model to better handle the specific weather condition. When the machine learning model is deployed, machine learning system 204 may use input weights 402a-402c to control the influence of each LoRA adapter 206a-206c. For instance, in a cloudy scenario, machine learning system 204 may activate LoRA1 206a (cloudy adapter) with a high input weight, while keeping other adapters like LoRA2 206b (night adapter) inactive with low weights.

In an aspect, input weights 402a-402c may allow the machine learning model to dynamically adapt to the current weather conditions based on real-time sensor data.

In an aspect, machine learning system 204 may train LoRA adapters 206a-206c faster and the training process may require less memory as compared to retraining the entire machine learning model for each weather condition.

In an aspect, the machine learning model with its core functionalities may remain intact. Advantageously, during inference, LoRA adapters 206a-206c may add weather-specific adjustments without discarding the knowledge learned by the machine learning model from the overall driving scenes dataset. Input weights 402a-402c may allow for smooth adaptation between weather conditions.

FIG. 6 is a block diagram illustrating an example system that may include a weather classifier in accordance with the techniques of this disclosure. In an aspect, as vehicle 102 (e.g., self-driving car) navigates its environment, LIDAR sensor 128 may capture a continuous stream of 3D points. Such 3D points, together, may form a point cloud sequence 602, providing a detailed picture of the surroundings over time. In an aspect, machine learning system 204 may have a separate weather condition classifier (weather classifier 209) as part of the system. In an aspect, the weather classifier 209 may be a simple convolutional neural network (CNN) trained on labeled images or LiDAR scans categorized by weather conditions (e.g., rainy, dark, snow, clear).

In an aspect, the weather classifier 209 may take the input image/scan (camera image or LiDAR point cloud sequence 602) and may predict the most likely weather condition based on features of the LiDAR point cloud sequence 602. As mentioned before, machine learning system 204 may include a set of LoRA adapters 206a-206c, each corresponding to a specific weather condition (rainy adapter, night adapter, etc.). The LoRA adapters 206a-206c may be trained on datasets 502-510 specific to their respective weather conditions. Once the weather classifier 209 predicts the current weather condition (e.g., rainy), the machine learning system 204 may identify the corresponding LoRA adapter 206 (rainy adapter represented by LoRA 3 206c in this case). The machine learning system may than set the corresponding weights 402a-402c of the LoRA adapters 206a-206c based on the confidence score generated by the weather classifier 209. For example, if weather classifier 209 detects a snowy night scene, machine learning system 204 may set all the LoRA weights 402a-402c to zero except for snow and night, and the snow and night LoRA adapters 206 may be weighted at 1. For a clear sky during the day (baseline model), all LoRA adapters may be set to zero.

The disclosed techniques are straightforward to implement. Setting weights to zero or one creates a clear distinction between active and inactive adapters.

In an aspect, the weather classifier 209 may predict multiple labels (classes) for a single image, allowing for more nuanced weather recognition. Based on the real-time weather conditions (detected by the weather classifier 209), the machine learning system 204 may activate appropriate LoRA adapter 206a-206c, which may influence the subsequent object tracking process.

In an aspect, the disclosed machine learning system may also employ a weight scaling with probabilities techniques. The weight scaling technique may use the prediction probabilities (confidence scores) of weather classifier 209 to dynamically adjust the weights 402a-402c of each LoRA adapter 206a-206c. The weight scaling technique may allow for a more nuanced adaptation strategy. The LoRA weights 402a-402c may not be limited to being completely on or off. The weights may be scaled smoothly based on the confidence in each prediction. By considering the probabilities, the machine learning system 204 may account for the uncertainty in the environment. For example, a low confidence in rain may lead to a less aggressive scaling of the rain-specific LoRA adapter 206c. In the scenario described, the high probability of rain may justify a stronger activation (e.g., higher weights 402a-402c) of the rain-specific LoRA adapter 206c, while the low fog probability may translate to a weaker activation (e.g., lower weights 402a-402c) of the fog-specific LoRA adapter. This way, the machine learning system 204 may prioritize the most likely weather condition while still considering the possibility of others.

In FIG. 6, the 3D object detection model 207 may identify objects (cars, pedestrians, cyclists) in each frame of the LiDAR point cloud sequence 602. The 3D object detection module 207 may analyze the 3D points and may predict bounding boxes 604 around the detected objects in 3D space. As discussed earlier, LoRAs are efficient for adapting models to different weather conditions. In an aspect, each LoRA adapter 206 may be integrated into the 3D object detection model 207, potentially at a layer before the final prediction stage where bounding boxes 604 are generated. Based on the real-time weather condition (detected by weather classifier 209), machine learning system 204 may activate the appropriate LoRA adapter 206 to influence the object detection process.

As a non-limiting example, the rain LoRA adapter 206c may help the 3D object detection model 207 better handle occlusions caused by rain. For instance, the rain LoRA may help 3D object detection model 207 to adjust the 3D point filtering process to reduce noise caused by raindrops. The rain LoRA adapter 206c may also help 3D object detection model 207 to fine-tune the bounding box 604 prediction to account for potential distortions caused by rain on the LiDAR points. In an aspect, once the 3D object detection model 207 identifies objects in a frame, the 3D tracking model 252 takes over. The 3D tracking model 252 may be trained to keep track of the predicted bounding boxes 604 across consecutive frames in the sequence, associating them with the same object over time. Tracking predicted boxes 604 may help the machine learning system 204 to understand the movement and behavior of objects in the scene. Advantageously, LoRA adapters 206 may improve the performance of the 3D object detection model 207 in various weather conditions, leading to more accurate bounding boxes 604. By having more accurate initial detections, the 3D tracking model 252 may perform better, maintaining consistent object identification throughout the LiDAR point-cloud sequence 602.

Furthermore, by combining accurate detection and tracking, the machine learning system 204 may gain a more comprehensive understanding of the dynamic scene, which may be essential for safe navigation. It should be noted that designing LoRA adapters 206 specifically for the chosen 3D object detection model architecture may require careful selection of the layers where the LoRA adapters 206 are integrated.

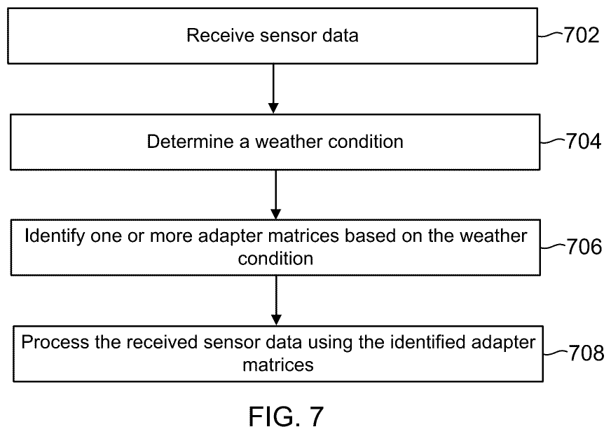

FIG. 7 is a flowchart illustrating an example method for providing sensor metadata using sensor imaging tensor in accordance with the techniques of this disclosure. Although described with respect to computing system 200 (FIG. 2), it should be understood that other devices may be configured to perform a method similar to that of FIG. 7.

In this example, machine learning system 204 may initially receive image data and sensor data from one or more sensor of vehicle 102 (702). Sensor data may include LiDAR data, image data, video data, and so on. The machine learning system 204 may determine a weather condition based on the received sensor data (704). In an aspect, the weather classifier 209 may take the input image/scan (camera image or LiDAR point cloud sequence 602) and may predict the most likely weather condition based on features of the LiDAR point cloud sequence 602. Next, the machine learning system 204 may identify one or more adapter matrices of a plurality of adapter matrices (LoRAS 206) integrated within one or more layers of a machine learning model based on the determined weather condition (706). In an aspect, during training, each LoRA adapter 206a-206c may learn to modify the features extracted by the machine learning model to better handle the specific weather condition. The machine learning system 204 may process the received sensor data, using the one or more identified LoRA adapters 206a-206c, to identify and/or track one or more objects in the received sensor data. (708). As a non-limiting example, the rain LoRA adapter 206c may help the 3D object detection model 207 better handle occlusions caused by rain. For instance, the rain LoRA may help 3D object detection model 207 to adjust the 3D point filtering process to reduce noise caused by raindrops.

The following numbered clauses illustrate one or more aspects of the devices and techniques described in this disclosure.

Clause 1. A method for processing image data includes receiving sensor data generated by one or more sensors of an autonomous vehicle and determining a weather condition based on the received sensor data. The method also includes identifying one or more adapter matrices of a plurality of adapter matrices integrated within one or more layers of a machine learning model based on the determined weather condition; and processing the received sensor data, using the one or more identified adapter matrices, to identify and/or track one or more objects in the received sensor data.

Clause 2—The method of clause 1, wherein the sensor data comprises a point cloud sequence

Clause 3—The method of clause 1, wherein determining the weather condition further comprises: determining the weather condition using a weather classifier.

Clause 4—The method of any of clauses 1-3, wherein identifying the one or more adapter matrices further comprises: multiplying each of the one or more adapter matrices by a corresponding input weight.

Clause 5—The method of any of clauses 1-4, wherein a rank of each of the one or more adapter matrices is smaller than dimensionality of one or more feature spaces the one or more adapter matrices interact with.

Clause 6—The method of any of clauses 1-5, wherein each of the one or more adapter matrices are trained using a dataset corresponding to a specific weather condition.

Clause 7—The method of clause 1, wherein processing the received sensor data further comprises: generating a bounding box for each of the one or more objects, wherein the bounding box indicates location and size of the corresponding object in three dimensional (3D) space.

Clause 8—The method of any of clauses 6 and 7, wherein processing the received sensor data further comprises: modifying, by the one or more adapter matrices, one or more features processed by one or more layers of the machine learning model before the processed features are sent to a next feature space.

Clause 9—The method of any of clauses 1-8, further comprising operating an Advanced Driver Assistance Systems (ADAS) system based on the processed sensor data.

Clause 10. An apparatus for processing image data, the apparatus comprising: a memory for storing sensor data; and processing circuitry in communication with the memory, wherein the processing circuitry is configured to: receive the sensor data generated by one or more sensors of an autonomous vehicle; determine a weather condition based on the received sensor data; identify one or more adapter matrices of a plurality of adapter matrices integrated within one or more layers of a machine learning model based on the determined weather condition; and process the received sensor data, using the one or more identified adapter matrices, to identify and/or track one or more objects in the received sensor data.

Clause 11—The apparatus of clause 10, wherein the sensor data comprises a point cloud sequence.

Clause 12—The apparatus of clause 10, wherein the processing circuitry configured to determine the weather condition is further configured to: determine the weather condition using a weather classifier.

Clause 13—The apparatus of any of clauses 10-12, wherein the processing circuitry configured to identify the one or more adapter matrices is further configured to: multiply each of the one or more adapter matrices by a corresponding input weight.

Clause 14—The apparatus of any of clauses 10-13, wherein a rank of each of the one or more adapter matrices is smaller than dimensionality of one or more feature spaces the one or more adapter matrices interact with.

Clause 15—The apparatus of any of clauses 10-14, wherein each of the one or more adapter matrices are trained using a dataset corresponding to a specific weather condition.

Clause 16—The apparatus of clause 10, wherein the processing circuitry configured to process the received sensor data is further configured to: generate a bounding box for each of the one or more objects, wherein the bounding box indicates location and size of the corresponding object in three dimensional (3D) space.

Clause 17—The apparatus of any of clauses 15 and 16, wherein the processing circuitry configured to process the received sensor data is further configured to: modify, by the one or more adapter matrices, one or more features processed by one or more layers of the machine learning model before the processed features are sent to a next feature space.

Clause 18—The apparatus of any of clauses 10-17, wherein the processing circuitry is further configured to operate an Advanced Driver Assistance Systems (ADAS) system based on the processed sensor data.

Clause 19—Non-transitory computer-readable storage media having instructions encoded thereon, the instructions configured to cause processing circuitry to: receive the sensor data generated by one or more sensors of an autonomous vehicle; determine a weather condition based on the received sensor data; identify one or more adapter matrices of a plurality of adapter matrices integrated within one or more layers of a machine learning model based on the determined weather condition; and process the received sensor data, using the one or more identified adapter matrices, to identify and/or track one or more objects in the received sensor data.

Clause 20—The non-transitory computer-readable storage media of clause 19, wherein the sensor data comprises a point cloud sequence.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media may include one or more of RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method for processing image data comprising:
receiving sensor data generated by one or more sensors of an autonomous vehicle;
determining a weather condition based on the received sensor data;
identifying one or more adapter matrices of a plurality of adapter matrices integrated within one or more layers of a machine learning model based on the determined weather condition; and
processing the received sensor data, using the one or more identified adapter matrices, to identify and/or track one or more objects in the received sensor data.

2. The method of claim 1, wherein the sensor data comprises a point cloud sequence.

3. The method of claim 1, wherein determining the weather condition further comprises:
determining the weather condition using a weather classifier.

4. The method of claim 1, wherein identifying the one or more adapter matrices further comprises:
multiplying each of the one or more adapter matrices by a corresponding input weight.

5. The method of claim 1, wherein a rank of each of the one or more adapter matrices is smaller than dimensionality of one or more feature spaces the one or more adapter matrices interact with.

6. The method of claim 1, wherein each of the one or more adapter matrices are trained using a dataset corresponding to a specific weather condition.

7. The method of claim 1, wherein processing the received sensor data further comprises:
generating a bounding box for each of the one or more objects, wherein the bounding box indicates location and size of the corresponding object in three dimensional (3D) space.

8. The method of claim 1, wherein processing the received sensor data further comprises:
modifying, by the one or more adapter matrices, one or more features processed by one or more layers of the machine learning model before the processed features are sent to a next feature space.

9. The method of claim 1, further comprising operating an Advanced Driver Assistance Systems (ADAS) system based on the processed sensor data.

10. An apparatus for processing image data, the apparatus comprising:
a memory for storing sensor data; and
processing circuitry in communication with the memory, wherein the processing circuitry is configured to:
receive the sensor data generated by one or more sensors of an autonomous vehicle;
determine a weather condition based on the received sensor data;
identify one or more adapter matrices of a plurality of adapter matrices integrated within one or more layers of a machine learning model based on the determined weather condition; and
process the received sensor data, using the one or more identified adapter matrices, to identify and/or track one or more objects in the received sensor data.

11. The apparatus of claim 10, wherein the sensor data comprises a point cloud sequence.

12. The apparatus of claim 10, wherein the processing circuitry configured to determine the weather condition is further configured to:
determine the weather condition using a weather classifier.

13. The apparatus of claim 10, wherein the processing circuitry configured to identify the one or more adapter matrices is further configured to:
multiply each of the one or more adapter matrices by a corresponding input weight.

14. The apparatus of claim 10, wherein a rank of each of the one or more adapter matrices is smaller than dimensionality of one or more feature spaces the one or more adapter matrices interact with.

15. The apparatus of claim 10, wherein each of the one or more adapter matrices are trained using a dataset corresponding to a specific weather condition.

16. The apparatus of claim 10, wherein the processing circuitry configured to process the received sensor data is further configured to:
generate a bounding box for each of the one or more objects, wherein the bounding box indicates location and size of the corresponding object in three dimensional (3D) space.

17. The apparatus of claim 10, wherein the processing circuitry configured to process the received sensor data is further configured to:
modify, by the one or more adapter matrices, one or more features processed by one or more layers of the machine learning model before the processed features are sent to a next feature space.

18. The apparatus of claim 10, wherein the processing circuitry is further configured to operate an Advanced Driver Assistance Systems (ADAS) system based on the processed sensor data.

19. Non-transitory computer-readable storage media having instructions encoded thereon, the instructions configured to cause processing circuitry to:
receive the sensor data generated by one or more sensors of an autonomous vehicle;
determine a weather condition based on the received sensor data;
identify one or more adapter matrices of a plurality of adapter matrices integrated within one or more layers of a machine learning model based on the determined weather condition; and
process the received sensor data, using the one or more identified adapter matrices, to identify and/or track one or more objects in the received sensor data.

20. The non-transitory computer-readable storage media of claim 19, wherein the sensor data comprises a point cloud sequence.
